(19) United States
(12) Patent Application Publication
(10) Pub. No.: US 2026/0369998 A1
(43) Pub. Date: Nov. 19, 2026

(54) SYSTEM FOR STABILIZING POWER SYSTEMS

(71) Applicant: Utility Innovation Group, LLC, Raleigh, NC (US)

(72) Inventors: Hashim Al Hassan, Katy, TX (US); Thomas Blooming, Smyrna, GA (US); Joseph Gammie, Atlanta, GA (US); Jennifer Stewart, Salina, KS (US); William Stewart, Salina, KS (US); Derek Tugwell, Raleigh, NC (US); Jonathan Tugwell, Raleigh, NC (US)

(21) Appl. No.: 19/210,484

(22) Filed: May 16, 2025

(51) Int. Cl. H02J 3/0014; H02J 3/32; H02J 3/38; H02J 3/388; H02J 3/40; H02J 7/82; H02J 103/35

(52) U.S. Cl. CPC H02J 3/0014; H02J 3/32; H02J 3/381; H02J 3/388; H02J 3/40; H02J 7/82; H02J 2103/35

(57) ABSTRACT

Disclosed is a system and methods for power stabilization of both utility-supported and islanded power systems subject to load instability conditions. The system includes a load, an energy storage platform, a system controller, and a system power distribution bus. The energy storage platform is configured for storing power at a determined state of charge and discharging the power to stabilize potentially volatile power systems. The system may also include a power generation platform configured for powering the load and the energy storage platform. The system controller is configured for monitoring the system; determining an optimal level of energy storage for the energy storage platform; detecting a load instability condition within the system; and applying a system control algorithm to the system to correct the load instability condition, in conjunction with an energy storage controller, an inverter controller, and a generator controller.

### BACKGROUND

The recent advancements in artificial intelligence (AI) and machine learning (ML) capabilities have accelerated the adoption of AI/ML technologies and expanded their use cases across industries and end users to unprecedent rates. This has prompted a renewed focus on leveraging existing data and expanding AI training efforts, requiring the construction of new data centers directed to this purpose; however, these data centers often present numerous issues when it comes to providing stable, consistent power given their highly volatile load profiles.

Developers and data center companies are faced with very long grid interconnection queues making it difficult to provide computer resources for existing AI training needs. As such, data centers often benefit from the utilization of a “microgrid” for their power requirements, utilizing privately owned and operated systems for power generation and stabilization rather than solely relying on a commercial utility source (e.g., a commercial electrical grid).

Conventional microgrids may utilize power generation and energy storage systems to provide a stable supply of energy; however, these conventional microgrids present two distinct problems. First, many conventional microgrids require what is known as a “spinning reserve” of power generation assets (e.g., generators) to be constantly running in order to quickly respond to changes in loads. This imposes significant fuel costs to ensure consistently reliable and responsive power to the load. Second, some conventional microgrids utilize assets that rely on carbon-based fuel (e.g., a diesel generator) due to the comparatively easy access of their fuel and their predictable high performance. This may impose additional costs and restrictions for the entire endeavor as data centers strive to shift to cleaner fuel sources. Furthermore, while some conventional microgrids may utilize decarbonized or reduced carbon footprint power sources (e.g., solar power, fuel cells, linear generators, lean burn natural gas engines, etc.), their performance for dynamic or volatile loads is generally considered poor, as they are not able to provide robust power system performance to stabilize volatile load systems both quickly and sufficiently.

As such, there is a demonstrated need for a resilient energy system that can provide power on the very short time domain with the integrated asset coordination required to respond to and stabilize loads with variable and volatile power requirements.

In some aspects, the techniques described herein relate to a system for power stabilization, including: at least one load; an energy storage platform configured for providing power to the at least one load; at least one system controller configured for monitoring the system, determining an optimal level of energy storage for the energy storage platform, detecting a load instability condition within the system, and applying a system control algorithm to the system to correct the load instability condition; and a system power distribution bus configured for transferring power within the system.

In some aspects, the techniques described herein relate to an energy storage platform at least one energy storage system (ESS) configured for storing and discharging power to the at least one load; at least one inverter unit, configured for converting between direct current (DC) power and alternating current (AC) power; and at least one energy storage platform bus configured for transferring power within the energy storage platform.

In some aspects, the techniques described herein relate to a method for stabilizing a power system supported by a utility source, comprising: determining, with at least one system controller, an optimal state of charge (SOC) for an energy storage platform to support at least one load with power and correct a load instability condition; determining, with the at least one system controller, an optimal number and type of assets of a power generation platform that are required to correct the load instability condition; charging, with the utility source, the energy storage platform to the optimal SOC; maintaining, with at least one energy storage controller, the optimal SOC of the energy storage platform; monitoring, with the at least one system controller, a voltage, a phase, and a frequency of alternating current (AC) power provided by the utility source; providing, with the energy storage platform, power to the at least one load; providing power to the at least one load; detecting, with the at least one system controller, the load instability condition; and applying, with the at least one system controller, a system control algorithm to correct the load instability condition.

In some aspects, the techniques described herein relate to a method for stabilizing an islanded power system, comprising: determining, with at least one system controller, an optimal state of charge (SOC) for an energy storage platform to support at least one load with power and correct a load instability condition; determining, with the at least one system controller, an optimal number and type of assets of a power generation platform that are required to correct the load instability condition; charging, with a direct current (DC) source, the energy storage platform to the optimal SOC; maintaining, with at least one energy storage controller, the optimal SOC of the energy storage platform; monitoring, with the at least one system controller, a voltage, a phase, and a frequency of alternating current (AC) power provided by the power generation platform; providing, with the energy storage platform, power to the at least one load; detecting, with the at least one system controller, the load instability condition; and applying, with the system controller, a system control algorithm to correct the load instability condition.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

In order to describe the manner in which the above-recited issues can be addressed, a more particular description of the principles briefly described above will be rendered by reference to specific embodiments thereof that are illustrated in the appended drawings.

Understanding that these drawings depict only exemplary embodiments of the disclosure and are not therefore to be considered to be limiting of its scope, the principles herein are described and explained with additional specificity and detail through the use of the accompanying drawings in which:

FIG. 1A depicts a block diagram of an exemplary embodiment of a system for power stabilization supported by a utility source, in accordance with the present technology.

FIG. 1B depicts a block diagram of an exemplary embodiment of a system for power stabilization in an islanded configuration, in accordance with the present technology.

FIG. 1C depicts a block diagram of an exemplary embodiment of a communications topology of a system for power stabilization in a microgrid, in accordance with the present technology.

FIG. 2 depicts a block diagram of an exemplary embodiment of an energy storage platform, in accordance with the present technology.

FIG. 3A illustrates an exemplary embodiment of an energy storage platform, in accordance with the present technology.

FIG. 3B illustrates an exemplary embodiment of an energy storage platform, in accordance with the present technology.

FIG. 4A illustrates a graphical depiction of the frequency response of the system after a loss of generation, in accordance with the present technology.

FIG. 4B illustrates a graphical depiction of the voltage response of the system after a loss of generation, in accordance with the present technology.

FIG. 4C illustrates a graphical depiction of power responses of the system and load after a loss of generation, in accordance with the present technology.

FIG. 5A illustrates a graphical depiction of the frequency response of the system after a loss of load, in accordance with the present technology.

FIG. 5B illustrates a graphical depiction of the voltage response of the system after a loss of load, in accordance with the present technology.

FIG. 5C illustrates a graphical depiction of power responses of the system and load after a loss of load, in accordance with the present technology.

FIG. 6A illustrates a graphical depiction of the frequency response of the system after a pulsing/cycling load, in accordance with the present technology.

FIG. 6B illustrates a graphical depiction of the voltage response of the system after a pulsing/cycling load, in accordance with the present technology.

FIG. 6C illustrates a graphical depiction of power responses of the system and load after a pulsing/cycling load, in accordance with the present technology.

FIG. 7A illustrates a graphical depiction of power responses of the system after a pulsing/cycling load with a fixed power output, in accordance with the present technology.

FIG. 7B illustrates a graphical depiction of power responses of the system after an operational fluctuation with a dynamically adjusting power output, in accordance with the present technology.

FIG. 8 illustrates a method for stabilizing a power system during normal operation, in accordance with the present technology.

FIG. 9 illustrates a method for stabilizing a power system following a loss of utility generation, in accordance with the present technology.

FIG. 10 illustrates a method for stabilizing a power system following a loss of load, in accordance with the present technology.

FIG. 11 illustrates a method for stabilizing a power system during an operational fluctuation, in accordance with the present technology.

### DETAILED DESCRIPTION

Various example embodiments of the disclosure are discussed in detail below. While specific implementations are discussed, it should be understood that this description is for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others. Any feature of one example can be integrated with or used with any other feature of any other example.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

For clarity of explanation, in some instances the present technology may be presented as including individual functional blocks representing devices, device components, steps or routines in a method embodied in software, or combinations of hardware and software.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

The present technology pertains to a novel energy management system, and specifically, a system for power stabilization which includes energy storage, a communication architecture, and a controls methodology. More specifically, the present technology pertains to the response of the system to a number of load instability conditions that, if left uncorrected, would compromise system reliability and risk microgrid outages.

In order to address the issues raised above in terms of how to provide stable, resilient power to a potentially volatile load, the present disclosure introduces a new system for power stabilization that is configured to manage the operations of a microgrid to provide power support and controlled flexibility to a load. In some aspects, the system for power stabilization includes an energy storage platform, which is configured to provide a reliable repository (i.e., storage) of energy sufficient to continuously provide power to the load in the event of a microgrid being islanded or a loss of utility generation (also referred to simply as a “loss of generation”). The energy storage platform may also be configured to correct operational fluctuations that may arise as a result of a highly variable load (e.g., the changing power demands of the electronics that support machine learning, artificial intelligence, etc.), specifically a pulsing/cycling load or a loss of load. The system for power stabilization is configured to store power supplied by a utility source (e.g., by a commercial electrical grid), which, when needed (e.g., in response to suddenly rising power demands of machine learning electronics), can provide power to the load, as well as to store the energy storage platform when excess power is available. The system for power stabilization is also configured to provide power to the load while disconnected from a commercial source of power (also referred to as an “islanded” microgrid).

In other aspects, the system for power stabilization includes a power generation platform configured to provide power to the energy storage platform and, in some instances, the load. In yet other aspects, the system for power stabilization includes a system control platform, which is configured to monitor the system's performance-including a status of the system's subcomponents-and enable power stabilization. More specifically, the system control platform is configured to detect, identify, and correct load instability conditions that arise by applying system control algorithms to the system for power stabilization as a whole. The system control algorithms issued by the system control platform directs the energy storage platform and the power generation platform to perform specific actions in response to the identified load instability condition, allowing corrective action to be taken quickly to stabilize the microgrid and the load without damage to any equipment or interruption of service.

Additionally, the system control platform ensures prolonged operation of the energy storage platform by managing the state of charge (SOC) of power storage elements within the energy storage platform, minimizing wear and tear of individual assets by ensuring they operate within their manufacturer guidelines from a minimum and maximum load perspective and maximum step load and unload.

In normal operation, a load (e.g., a data center) receives power from a utility source, such as a commercial electrical grid. Interruption of service and other load instability conditions between the utility source and the load represent a risk of violating utility voltage and frequency interconnection requirements of the utility source, as well as a risk to the operation of the load. Resiliency is provided by the system for power stabilization to minimize these risks. During normal operation, the energy storage platform may provide at least one energy storage system (ESS) having energy storage apparatuses to serve as a reliable, quickly accessible repository of power in the event of a load instability condition. An energy storage controller may monitor the state of charge (SOC) of the energy storage apparatuses, as well as control the energy storage apparatuses' response to charge and discharge as necessary to maintain system stability and/or a determined optimum SOC required to continuously support the load in the event of a load instability condition.

During normal operation in a utility-supported configuration, the ESS may be configured to receive power directly from the utility source, a DC source (e.g., on-site solar panels or diesel generators), or from a synchronous power generation platform directly. Power stored in the ESS is generally available as a direct current (DC) source that is converted to an alternating current (AC) through power inverters or analogous devices for converting DC current to AC current. Therefore, power sources that generate DC power may be coupled to such a device in a grid-following control scheme such as phase-locked loop (“PLL”) that synchronizes the inverter's output power (supplied by at least one ESS) to the utility source's alternating current (AC) power (i.e., the phase of the voltage/current). Such synchronization allows the energy storage platform to quickly (e.g., within a sub-cycle response timeframe) replace the utility source as a provider of power to the load (in the event of a loss or a mere deficit of utility generation) by constantly monitoring and mirroring the voltage and frequency of the utility source. For example, if the load were to suddenly become disconnected or insufficient from the utility source, the inverter(s) connected to the ESSes would immediately provide power in phase with the utility source to keep the voltage and frequency stable.

The power generation platform, which may be configured to provide power to the energy storage platform and, in some instances, the load, may include at least one distributed generation unit, which may include a generator and generator controller. In utility-supported configurations, the generators may be kept as a non-spinning reserve (extra generating capacity that is not connected or in synch to the system but can be brought online after a short delay to connect) to reduce power demands, unnecessary utilization, and/or operational costs absent a load instability condition. A system controller analyzes the power requirements of the load with and without a load instability condition, and based on that analysis, the system controller may keep one or more generators as a non-spinning reserve.

The energy storage platform may be configured to simultaneously enable control of voltage and frequency while also operating in a fixed power command, which are generally considered to be conflicting requirements according to conventional technology. This may be achieved by the system controller determining the proper sequence by which the energy storage platform is energized, as well as the proper voltage and frequency bounds for the operation of the energy storage platform in a utility-supported configuration while utilizing a decentralized approach (e.g., the inverter controller responds without specific direction from a system controller). This allows the energy storage platform to operate around a zero active and reactive power setpoint. The decentralized action is taken locally without any sort of timing delay. As such, the system controller plays a primary role in the slower, more deliberate changes inherent to the system (e.g., measured over the course of multiple cycles as opposed to sub-cycle responses).

This decentralized approach to system control allows other assets (e.g., spinning generators) to provide power to the load while the microgrid remains within healthy voltage and frequency bounds and the energy storage platform responds to support voltage and frequency when the system experiences a load instability condition. Such decentralized system control may be enabled by the system controller's initial determination of an optimum SOC required for the energy storage platform to respond, as well as the system controller's coordination of any natural and programmed time delays between the assets. This communication architecture enables the system as a whole to operate using both droop and isochronous control as conditions demand.

When operating without the support of a utility source, the system for power stabilization is said to be “islanded”; however, this is not an uncommon configuration for microgrids supporting large variable loads. In islanded configurations, the ESSes may be configured to receive power from a DC source (e.g., on-site solar panels or fuel cells) or from the power generation platform directly. The inverter controllers may instead be set to droop or isochronous control, enabling the inverters to control the output voltage and frequency of the energy storage platform to meet load requirements and correct load instability conditions with support from the power generation platform.

Depending upon load requirements and stability, the power generation platform (e.g., the generators) may be configured to provide fixed, non-variable power to the load, as well as maintaining the requisite SOC for the energy storage apparatuses of the energy storage platform. In some instances, the power generation platform (e.g., the generators) may instead be configured to provide more or less power to the energy storage apparatuses to force the energy storage platform to charge or discharge to maintain a predetermined SOC while simultaneously responding to operational fluctuations resulting from volatile load requirements (e.g., a pulsing/cycling load).

In the event of a loss of utility generation, the system controller is configured to transition the system for power stabilization from a grid-supported configuration to an islanded configuration. The system controller does so by first isolating the load from the utility source, such as by opening an interconnection point, which may be further configured to monitor the voltage and frequency of the power provided by the utility source. The energy storage platform is then configured to stabilize the load by exporting power from the energy storage apparatuses to the load. The inverters instantaneously transition from a grid-following control scheme to a grid-forming control scheme as the system controller sends a signal to the power generation platform to generate power, such as by starting the non-spinning reserve of generators. Once power is generated such as with a requisite number of generators operating in parallel, the assets of the power generation platform (e.g., generators) may be synced across the microgrid with the energy storage platform to ensure that the power provided by the power generation platform assets and by the energy storage platform are in phase. Such synchronization may be provided by, for example, PLLs described above. Upon syncing the assets of the power generation platform (e.g., generators), the system for power stabilization is considered to be in an islanded configuration, and the load is no longer dependent upon the utility source for its power requirements. The energy storage platform may then gradually reduce its discharge while the generators gradually “load” at a predetermined rate that is acceptable for the generators to fully hand off the load from the energy storage platform to the power generation platform in a stable manner.

In the event of a loss of load, where the load effectively becomes disconnected, a surplus of power in the system results in a considerable risk of damage to the system and its subordinate components. This risk is particularly great in islanded configurations. Generally, the surplus of available power in the system, if not properly controlled, may lead to excessive frequency of the AC power. In the event that the system controller of the system control platform detects a loss of load, it may direct the power generation platform to momentarily charge the energy storage apparatuses above their normal SOC to regulate the frequency absorbing the additional momentary generation. In that regard, the assets of the power generation platform (e.g., generators) gradually “unload,” meaning that they reduce their power output in a controlled manner. By momentarily charging the energy storage apparatuses above their normal SOC while gradually unloading the power generation platform, the energy storage apparatuses act as a temporary load and absorb the power surplus present within the system.

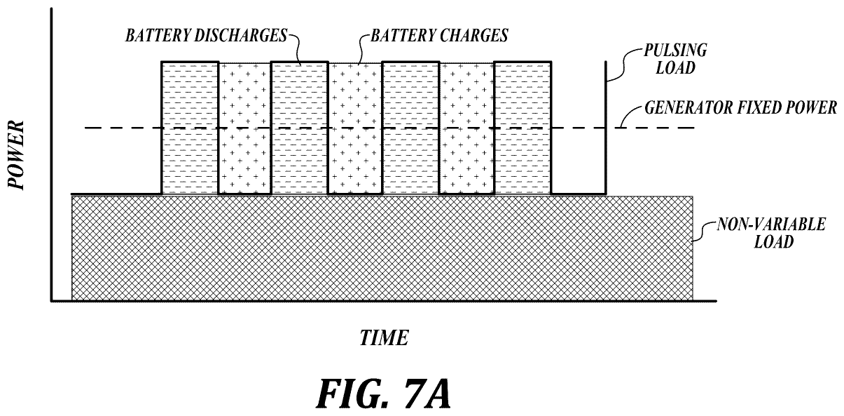

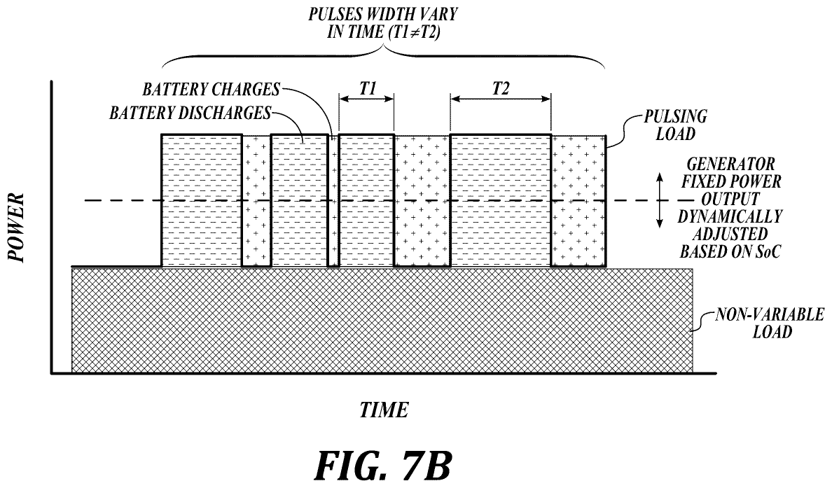

In the event of a pulsing/cycling load, wherein the load profile is subject to rapid and variable changes (e.g., rapid changes in machine learning or artificial intelligence computations)—the system for power stabilization is configured to provide the requisite voltage and frequency stability to the load to mitigate the risk of damage to the entire system. For example, if a pulsing/cycling load is detected, the system controller may direct the power generation platform to stabilize the system. In some embodiments, the power generation platform may provide a periodic fixed power output to the load while the energy storage platform devotes power of the energy storage apparatuses to stabilizing the load. (See FIG. 7A.) As discussed above, the energy storage platform may be configured to simultaneously enable control voltage and frequency while also maintaining a determined SOC. While generally there exists a conflict between voltage and frequency stabilization (voltage control) and maintaining SOC (current control), both are necessary for a stabilized power system, and both can be achieved by coordinating with the power generation platform. The distributed generation units of the power generation platform may be configured such that the energy storage platform may absorb or inject power from or into the system by forcing either a surplus or a deficit of power. In some embodiments, the power generation platform may adopt a minimum import/export approach, where the assets of the power generation platform (e.g., generators) either (1) provide additional power to the load to force the battery to charge when the SOC becomes too low (minimum export), or (2) provide less power to the load, forcing the energy storage platform to discharge when the SOC becomes too high (minimum import). (See FIG. 7B).

The system may be decarbonized, meaning that its subordinate platforms may utilize assets and components that reduce or eliminate carbon dioxide emissions by instead utilizing renewable energy sources (e.g., solar panel arrays, fuel cells, linear generators, lean burn natural gas engines, etc.). As noted above, conventional decarbonized energy systems are an emerging field and are generally considered to be too instable to support large, volatile loads such as data centers directed toward machine learning or artificial intelligence applications.

However, the system for power stabilization and associated methods therewith may be configured to provide the response and power supply necessary to support these types of loads with varying generation technologies.

The above-described benefits as well as other benefits of the system for power stabilization and associated methods therewith will become further appreciated from the description that follows.

Examples of a system for power stabilization in a microgrid will now be described. As noted above, the microgrid may be configured as a utility-supported configuration (connected to a utility source, such as the electrical grid), or an “islanded” microgrid (disconnected from a commercial source of power). In that regard, examples of a system for power stabilization in a microgrid in accordance with the present technology will be described for both a utility-supported configuration and an islanded configuration.

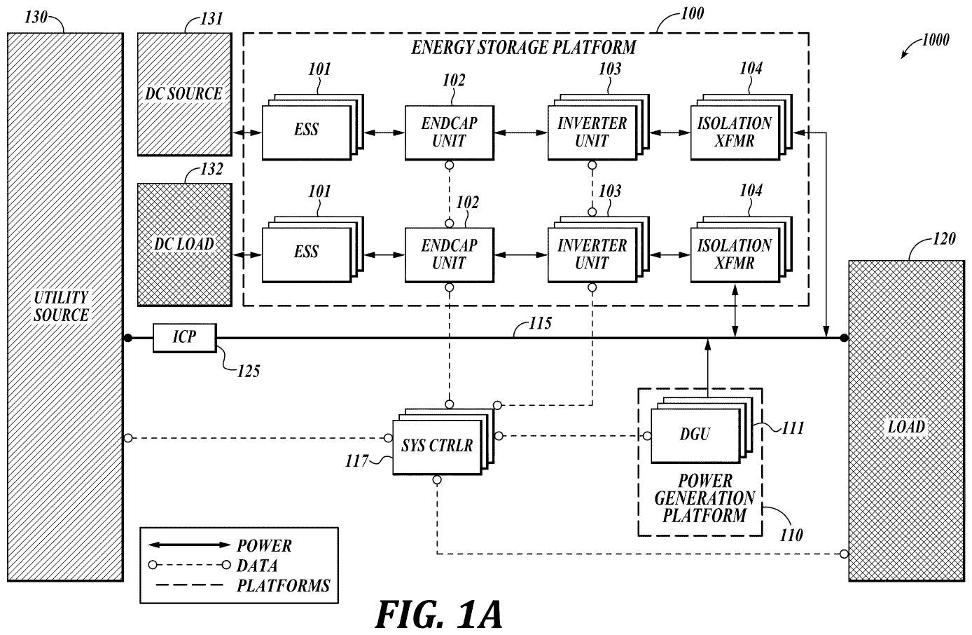

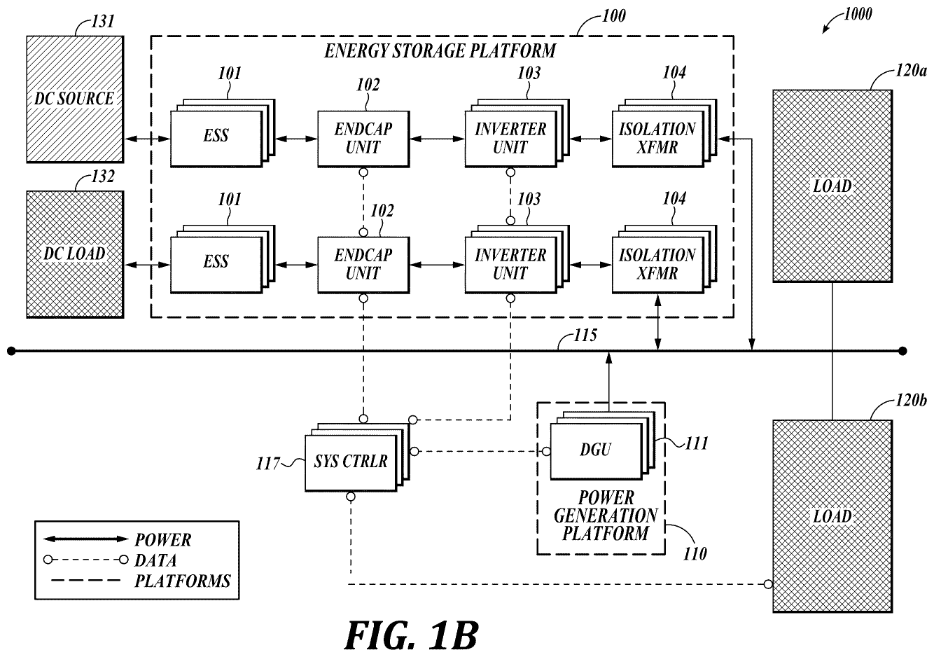

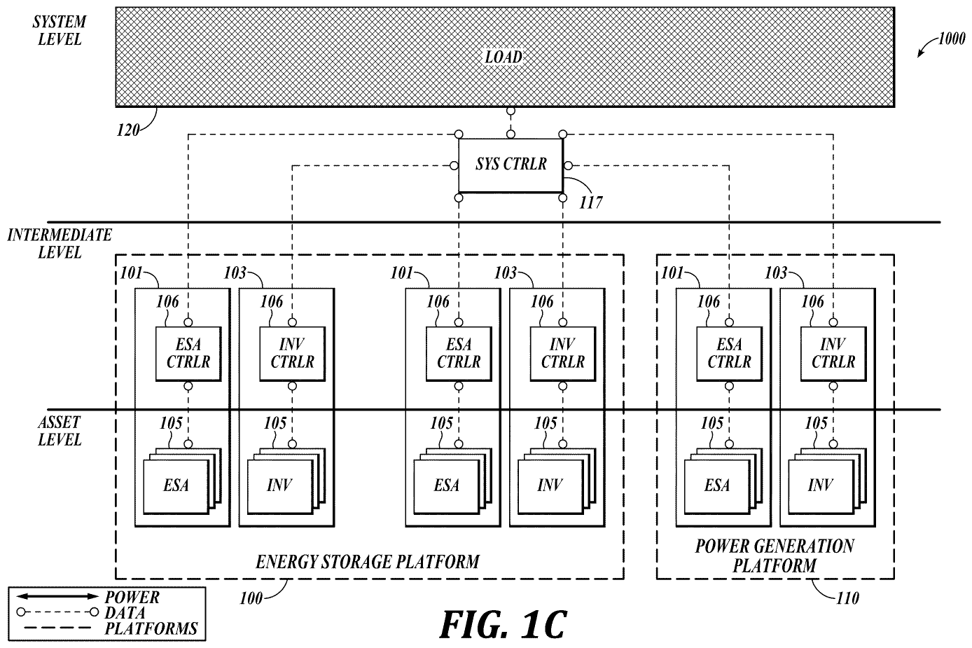

FIG. 1A depicts a block diagram of an exemplary embodiment of a utility-supported system 10000 for energy storage resiliency in a microgrid for a utility-supported configuration. Generally, the utility-supported system 10000 may include an energy storage platform 100, a power generation platform 110, at least one system controller 117, and at least one load 120. In a utility-supported configuration, such as the one depicted in FIG. 1A, the utility-supported system 10000 may include a utility source 130. In an islanded configuration, such as the one depicted in FIG. 1B, a system 11000 for power stabilization may operate without a utility source 130. In some embodiments, the system 10000 includes a system power distribution bus 115, which may be configured for transferring power within the system. In some embodiments, the system power distribution bus 115 is electrically coupled with the energy storage platform 100, the power generation platform 110, the at least one system controller 117, and the at least one load 120.

In a utility-supported system 10000, such as the one depicted in FIG. 1A, the utility source 130 may be connected to the system power distribution bus 115 via an interconnection point 125, which may be configured to isolate the utility source 130 from the system power distribution bus 115. In some embodiments, the interconnection point 125 may be a recloser switch, circuit breaker, static switch assembly, or similar.

Exemplary aspects of the utility-supported system 10000 and system 11000 are identical, and therefore, the same part numbers are used in FIG. 1A and FIG. 1B. In that regard, any part described with reference to the utility-supported system 10000 of FIG. 1A may also apply to the same part shown in FIG. 1B. A general description of each system will first be provided, followed by a more detailed description of various components therein.

In accordance with the discussion above, the energy storage platform 100 may be configured to correct conditions that may arise as a result of a highly variable load 120 (e.g., machine learning, artificial intelligence, etc.) experiencing an operational fluctuation (e.g., a pulsing/cycling load or a loss of load). In a utility-supported configuration, the energy storage platform 100 may also be configured to provide a reliable repository of power sufficient to continuously provide power to the load 120 in the event of an operational fluctuation, such as a loss of generation or a pulsing/cycling load. In some embodiments, the energy storage platform 100 includes at least one energy storage system 101 (ESS).

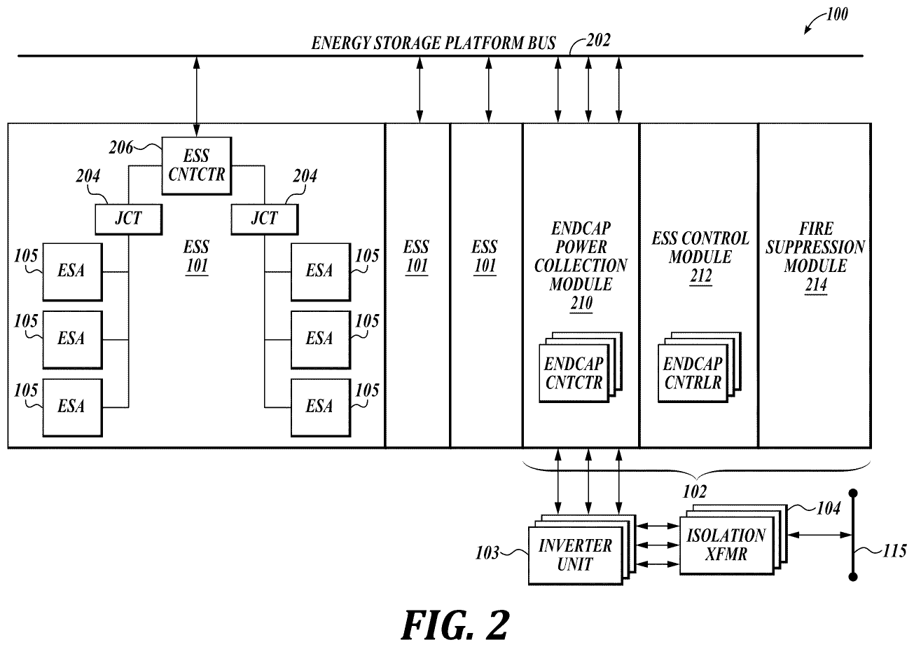

The ESS 100 may be configured for receiving power from a power source such as the utility source 130, storing the power received, and discharging stored power in support of the load 120 and utility-supported system 10000 functions. In that regard, the ESS 101 may include, as shown, a plurality of energy storage apparatus 105, at least one junction box 204, and an ESS contactor 206 (see also FIG. 1B, FIG. 2). As will be described further below, the energy storage platform 100 may include an endcap unit 102 configured for housing additional components and subordinate modules in support of the reliable function of the energy storage platform 100 (see FIG. 2).

In the examples described herein, the energy storage platform 100 also includes at least one inverter unit 103 configured for converting direct current (DC) power and alternating current (AC) power. Each of the at least one inverter units 103 may include an inverter 107 and an inverter controller 108 (see FIG. 1C).

In some embodiments, the energy storage platform 100 includes at least one isolation transformer 104 configured for transferring power between the energy storage platform and the utility-supported system 10000, adjusting voltage levels between the energy storage platform 100 and the utility-supported system 10000 to satisfy system 10000 and load 120 requirements, as well as isolating the energy storage platform from the load. In that regard, the isolation transformer 104 is configured for protecting the energy storage platform 100 from potential damage resulting from a highly variable load and potential load instability conditions.

In some embodiments, the energy storage platform 100, or more specifically the at least one ESS 101, is configured to receive power from a DC source 131. In some embodiments, the DC source is a renewable source of DC power (e.g., a solar panel array, fuel cell output, DC generator, electric vehicle, or similar). In other embodiments, the DC source is a non-renewable source of DC power (e.g., a diesel generator, fossil fueled engines, fuel cells, or similar). In some embodiments, the energy storage platform 100, or more specifically the at least one ESS 101 is configured to distribute power directly to a DC load 132, which may include electric vehicles, DC fast charging, DC network equipment, UPS supplies, AUX power, or similar. In the illustrated embodiment, the energy storage platform 100 is electrically coupled to both a DC source 131 and a DC load.

As discussed above, the power generation platform 110 may be configured to provide power to the energy storage platform 100 as well as to the load 120. In the example shown, the power generation platform 110 includes at least one distributed generation unit 111. In some embodiments, the at least one distributed generation unit 111 includes a generator 112 configured for providing power to the utility-supported system 10000 and/or load 120 and a generator controller 113 configured for monitoring voltage and frequency of the power output from the at least one generator (see FIG. 1C).

As also discussed above, the at least one system controller 117 may be configured to monitor the performance of the utility-supported system 10000 and its subcomponents. In some embodiments, the system 10000 may include more than one system controller 117 to provide a backup system controller 117 in the event of a system malfunction. In some embodiments, the at least one system controller 117 is communicatively coupled with the energy storage platform 100, the power generation platform 110, and the at least one load 120. More specifically, the at least one system controller 117 may be communicatively coupled with the at least one energy storage controller 106, the inverter controller 108, and the generator controller 113. In utility-supported embodiments, the at least one system controller 117 may also be communicatively coupled with the utility source 130.

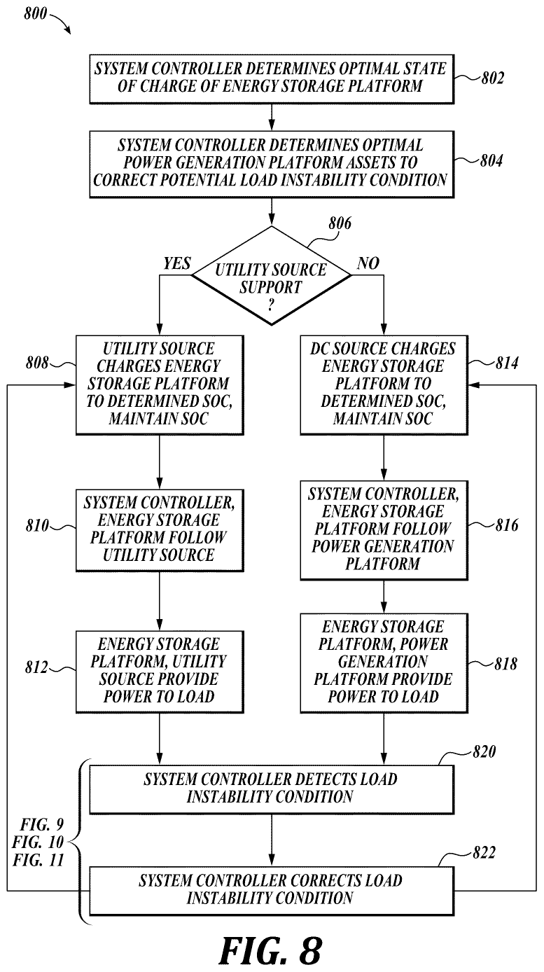

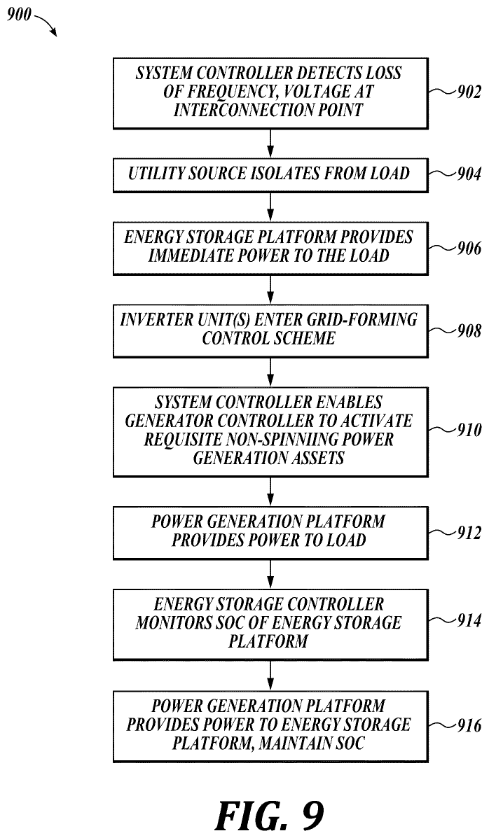

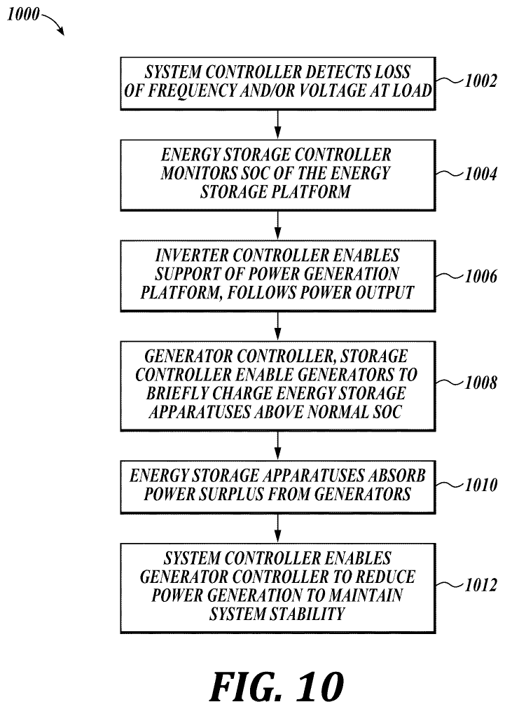

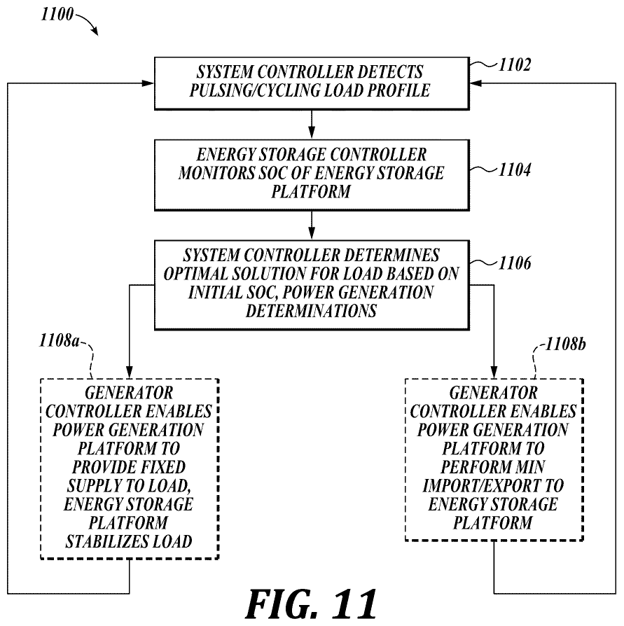

In some embodiments, the system controller 117 is configured for determining an optimal level of energy storage for the energy storage platform 100, including the optimal state of charge for the plurality of energy storage apparatus 105. The system controller may also be configured for determining the requisite number of generators 112 required to support the energy storage platform 100 and to correct a load instability condition. The system controller 117 may be configured to detect, identify, and correct load instability conditions that arise by applying system control algorithms to the utility-supported system 10000 as a whole (see FIG. 8, FIG. 9, FIG. 10, and FIG. 11). The system control algorithms issued by the system controller 117 may enable the energy storage platform 100 and the power generation platform 110 to perform specific actions according to control algorithms programmed into their commensurate apparatus controllers in response to the identified load instability condition, allowing corrective action to be taken quickly to stabilize the microgrid and the load without damage to any equipment or interruption of service. For example, a system control algorithm relating to a loss of load may enable the energy storage controller 106 to apply an energy storage control algorithm to the plurality of energy storage apparatuses 105, the generator controller 113 to apply a generator control algorithm to the distributed generation unit 111, and so on.

In some embodiments, the at least one system controller 117 may include a redundant network architecture that is also communicatively coupled with the energy storage platform 100, the power generation platform 110, and the at least one load 120. More specifically, the redundant network architecture may be communicatively coupled with the at least one energy storage controller 106, the inverter controller 108, and the generator controller 113. In utility-supported embodiments, the redundant network architecture may also be communicatively coupled with the utility source 130. The redundant network architecture, like the system controller 117, may be configured for monitoring the system and applying the system control algorithm to the system to correct any identified load instability conditions. In some embodiments, the redundant network architecture is a network switch, enabling the system 10000 to communicate internally with only a brief delay (1-5 ms) in the event that normal operations (embodied by the decentralized approach described above) are interrupted.

As noted above, FIG. 1B depicts a block diagram of an exemplary embodiment of a system for power stabilization in an islanded configuration, in accordance with the present technology.

In that regard, the energy storage platform 100 may be configured to provide continuous power to a load 120 when disposed in an islanded configuration. In an islanded configuration, the energy storage platform 100 may be configured to receive power from a DC source 131, rather than a commercial utility source 130. In that regard, the ESS 101 may be configured to charge its plurality of energy storage apparatuses 105 using power from this secondary power source 131. In some embodiments, the DC source 131 is a solar panel array, fuel cell output, DC generator, electric vehicle, or similar. In other embodiments, an islanded system 11000 does not rely on a secondary power source 131, instead generating all of its power through the power generation platform 110.

In some embodiments, the system 11000 may be configured to support multiple loads 120a, 120b. These multiple loads 120a, 120b may be multiple volatile loads (e.g., multiple AI/ML loads in need of stabilization). Alternatively, one load 120a may represent a volatile load, while another may represent a fixed, non-volatile load 120b of infrastructure supporting the volatile load (e.g., powering the lights of the AI/ML facility in which the volatile load 120a is disposed).

FIG. 1C depicts a block diagram of an exemplary embodiment of a communications topology of a utility-supported system 10000 or islanded system 11000 for power stabilization, in accordance with the present technology. In this exemplary embodiment, the communications topology can be best understood by breaking the larger platforms into their individual subcomponents and dividing them into three levels: an asset level, which includes the devices performing the tasks to manage, protect, and control the individual assets that make up a given system; an intermediate level, which includes the system interface controllers and connections that integrate the assets into the overall system; and finally the system level, which includes the system controller responsible for integrating and optimizing electrical load with the assets that make up a system, integrating users and operational parameters, communication with external systems, load, and the respective platforms.

Bridging the asset level and the intermediate level are components of the energy storage platform 100 and the power generation platform 110, specifically the ESS 101, the inverter unit 103 and the distributed generation unit 111. In some embodiments, there are an equal number of inverter units 103 as there are ESSes; however, other embodiments may require a lesser number of inverter units 103 depending upon the size and volatility of the load 120.

At the asset level are the plurality of energy storage apparatus 105, the inverters 107, and the generators 112. In some embodiments, the plurality of energy storage apparatuses may be batteries, capacitors, supercapacitors, compressed gasses, flywheels, or similar. In some embodiments, the energy storage apparatus 105 may have a high power output 1.5 C peak discharge capability, with industrial cooling and control components. The energy storage apparatus 105 may be a battery having a Li-NCA cell chemistry, or similar. In some embodiments, the inverters 107 are fully bidirectional and paralleled for reliability. The generators 112 may be synchronous power generation assets. In some embodiments, the generators 112 are lean or rich burn gas engines, hydrogenated vegetable oil engines, gas fired or steam turbines, hydrogen generators, fuel cells, or similar.

At the intermediate level are the controllers for each respective asset, specifically the energy storage controller 106, the inverter controller 108, and the generator controller 113. It should be understood that, while the diagram depicts each asset as having its own controller, this is not required for proper functionality. For example, multiple inverters 107 may be controlled by a single inverter controller 108. In some aspects, the at least one energy storage controller 106 may be configured to support energy storage asset modularity of the energy storage platform 100 (e.g., multiple ESSes).

It should be appreciated that the inclusion of controllers at the intermediate level allows for zero latency in initiating control algorithms across the system, as enabled by the system controller 117. In some embodiments, the energy storage controller 106, inverter controller 108, and generator controller 113 are configured to monitor voltage and frequency at each of their respective assets (e.g., voltage sensing at the terminals of the inverter 107 or individual energy storage apparatus 105) and implement control algorithms governing their power output. In some embodiments, the interconnection point 125 or equivalent is similarly able to provide continuous real-time monitoring of voltage and frequency as it relates to the power provided by the utility source. Such monitoring may allow the system controller 117 to determine the efficacy of energy storage apparatus, inverter, and generator control algorithms. This may also allow the system controller 117 to direct additional assets to quickly respond to more volatile load instability conditions (e.g., pulsing/cycling loads) that require a more variable response from the respective platforms to protect the system as a whole and provide resilient energy storage.

In some embodiments, the at least one system controller 117 may include a redundant network architecture that is also communicatively coupled with the at least one energy storage controller 106, the inverter controller 108, and the generator controller 113, bridging the system and intermediate levels. In utility-supported embodiments, the redundant network architecture may also be communicatively coupled with the utility source 130. The redundant network architecture, like the system controller 117, may be configured for monitoring the system and applying the system control algorithm to the system to correct any identified load instability conditions. In some embodiments, the redundant network architecture is a network switch, enabling the system 10000 to communicate internally with only a brief delay (1-5 ms) in the event that normal operations (embodied by the decentralized approach described above) are interrupted.

FIG. 2 depicts a block diagram of an exemplary embodiment of an energy storage platform 100, in accordance with the present technology.

As discussed above, the energy storage platform 100 may include at least one energy storage system 101 (ESS), though more than one ESS 101 is common for highly variable loads (as seen in the illustrated embodiment, which features three ESSes 101). In some embodiments, each ESS 101 can be incorporated into an energy storage platform 100 individually, allowing them to be deployed modularly based on the supported load or loads 120. Each ESS 101 may include a plurality of energy storage apparatuses 105, at least one junction box 204, and an ESS contactor 206, as shown. The operating temperature of each ESS 101 may be monitored and maintained by an energy storage controller 106 using a liquid coolant system, heat exchanger, refrigerant cooling unit, radiator fan, heater, HVAC system, or some combination thereof, or another form of heating or cooling electronics in an enclosed space.

The energy storage platform 100 may include an energy storage platform bus 202 configured for transferring power within the energy storage platform 100. The ESS contactor 206 may be configured for transferring power from the plurality of energy storage apparatuses 105 to the energy storage platform bus 202 via the junction box 204. The energy storage platform bus 202 may support the modular deployment of ESSes 101 by providing a shared “backbone” of power for the energy storage platform 100 as a whole, allowing individual ESSes 101 to be added or removed from an energy storage platform 100 as the load profile requires (as determined by the system controller). Accordingly, the total storage capacity of the energy storage platform 100 may be scaled up or down based upon the power requirements of a given load both during normal operations and while experiencing a load instability condition. In some embodiments, each ESS 101 further comprises an ESS fire suppression system (not pictured) configured for detecting and/or extinguishing a fire within the ESS 101.

In some embodiments, the energy storage platform 100 includes an endcap unit 102 configured for housing additional components and subordinate modules in support of the reliable function of the energy storage platform 100. The endcap unit 102 may include an endcap power collection module 210, which is comprised of at least one endcap contactor 208 configured for transferring DC power from the energy storage platform bus 202 to the at least one inverter unit 103. The endcap unit 102 may also include an ESS control module 212, which houses at least one energy storage controller 106. The energy storage controller 106 may be configured for charging and discharging the plurality of energy storage apparatus 105, as well as monitoring each of their respective states of charge. Additionally, the endcap unit 102 may include a fire response module 214 communicatively coupled with each ESS and configured for detecting and/or extinguishing a fire within the energy storage platform 100.

In addition, as discussed above, the energy storage platform 100 may include at least one isolation transformer 104 configured for transferring power between the energy storage platform and the system 10000, 11000, adjusting voltage levels and providing isolation between the energy storage platform and the system to satisfy load 120 requirements, as determined by the system controller. The isolation transformer 104 may also be configured for isolating the energy storage platform 100 from the load, protecting the energy storage platform 100 from potential damage from a highly variable load and resulting load instability conditions.

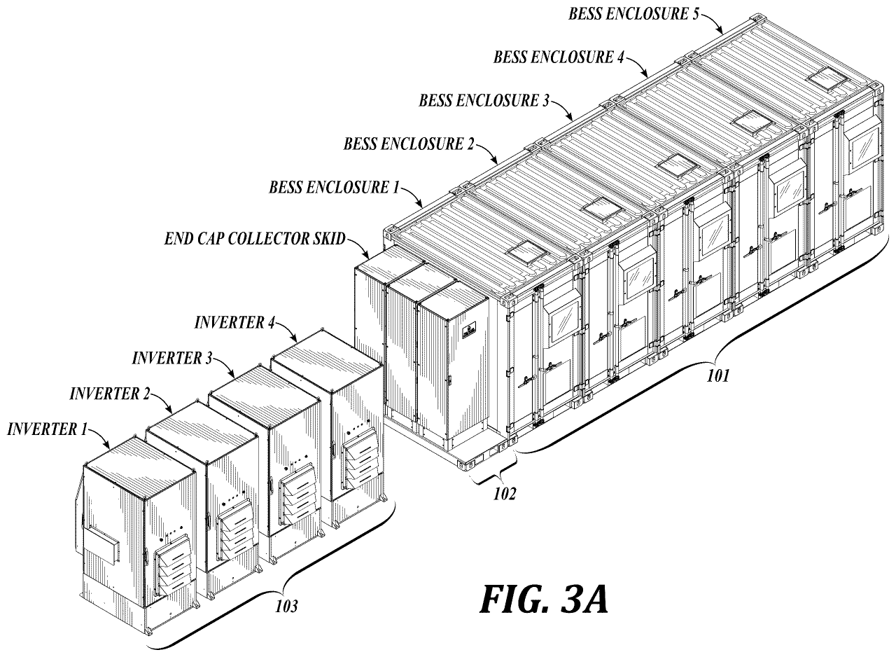

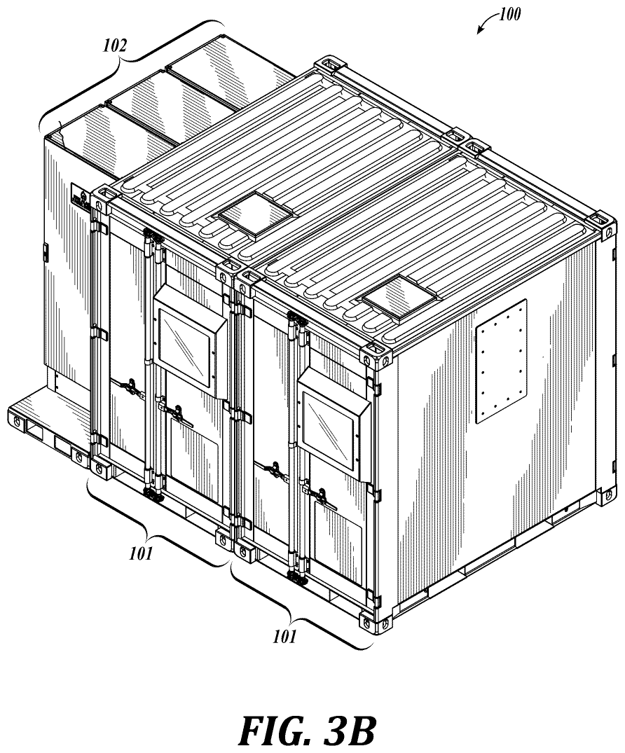

FIG. 3A and FIG. 3B illustrate exemplary embodiments of an energy storage platform, in accordance with the present technology. FIG. 3A depicts an energy storage platform 100 with five ESSes 101, four inverter units 103, and an endcap unit 102 with three different modules (e.g., an endcap power collection module, an ESS control module, and a fire response module). FIG. 3B depicts a smaller energy storage platform 100, with only two ESSes 101 and an endcap unit 102 (inverter units 103 and other components are not pictured). As discussed above, ESSes 101 may be deployed modularly to fulfill each individual load's energy storage requirements. In that regard, ESSes may be contained and transported utilizing on-sea containers for easy transport and installation.

It should be appreciated that the system 10000, 11000 or any other suitable system for power stabilization in accordance with the present technology may employ any suitable energy storage platform 100. Thus, the descriptions and illustrations provided herein should not be seen as limiting.

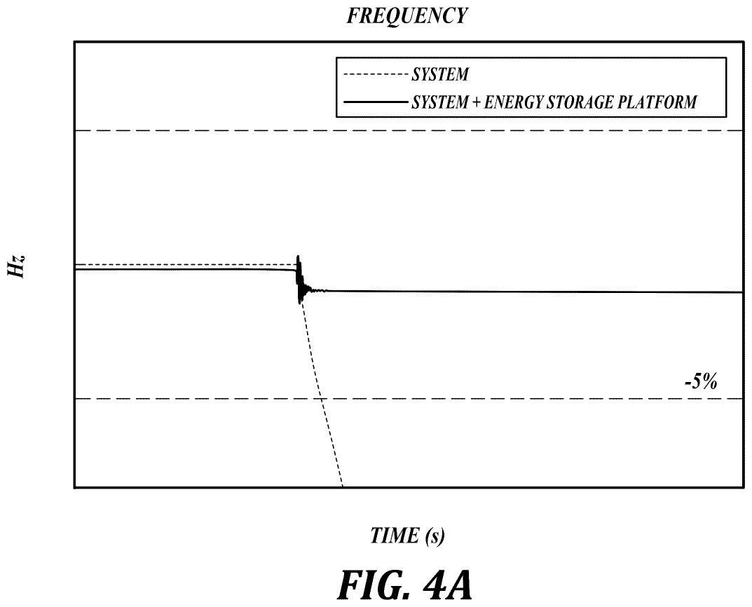

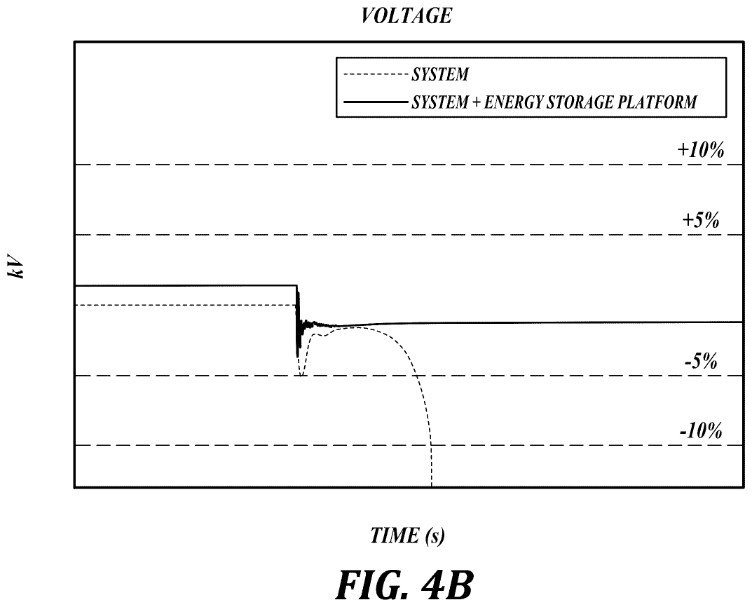

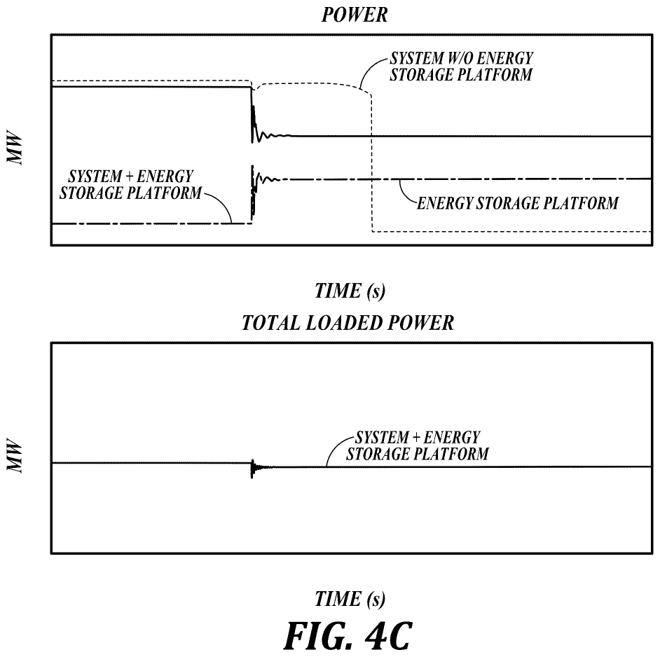

FIG. 4A and FIG. 4B illustrate graphical depictions of the frequency and voltage responses, respectively, of an electromagnetic transient (EMT) simulation of an islanded system with and without an energy storage platform during a loss of generation, in accordance with the present technology. Similarly, FIG. 4C illustrates a graphical depiction of the power responses of a system with and without an energy storage platform, and an energy storage platform alone during a loss of generation, in accordance with the present technology.

In the simulation illustrated graphically in FIGS. 4A, 4B, and 4C, four generators (in this instance, lean burn gas engines) were simulated for the system without an energy storage platform reliant on spinning reserve capacity, while the system with an energy storage platform featured three generators and relied upon non-spinning reserve capacity, in essence replacing one of the generators from the system without the energy storage platform. In each simulation, one generator is “dropped,” simulating a loss of one generation asset. It should be understood that the example embodiment reflected in this simulation is not intended to be limiting in regards to the number or type of generators present in each simulation.

Referring to the portions of each graph concerning the system without the energy storage platform, a loss of generation results in the system experiencing severe voltage and frequency deviations, with the generators unable to recover voltage and frequency, ultimately causing the system to shut down and fail to support the load. The sudden loss of generation leaves the system momentarily with a large load step on the remaining generation assets. Due to the slow response of the speed governor and fuel delivery system of simulated lean burn gas engines (and similar equipment), this step load results in system frequency and voltage decreasing quickly due to the sudden imbalance. The engine speed governor is unable to react in a timely manner to bring the system under control (to regulate the under-frequency) and the system controller is unable to regulate the under-voltage for such rapid voltage changes, resulting in failed system recovery, protection tripping, and shut down.

Referring next to the portions of each graph concerning the system with the energy storage platform, a loss of generation is quickly corrected with minimal impact with a simulated energy storage platform capable of injecting the requisite power to replace the loss of generation assets. The energy storage platform can be considered to be necessary as a reliability asset for the system as a whole. An alternative to ensure successful system recovery during a loss of generation may be to add an additional engine generation to reduce the size of the step load on the remaining assets; however, additional spinning reserve generation may result in additional cost that is not required with the present technology.

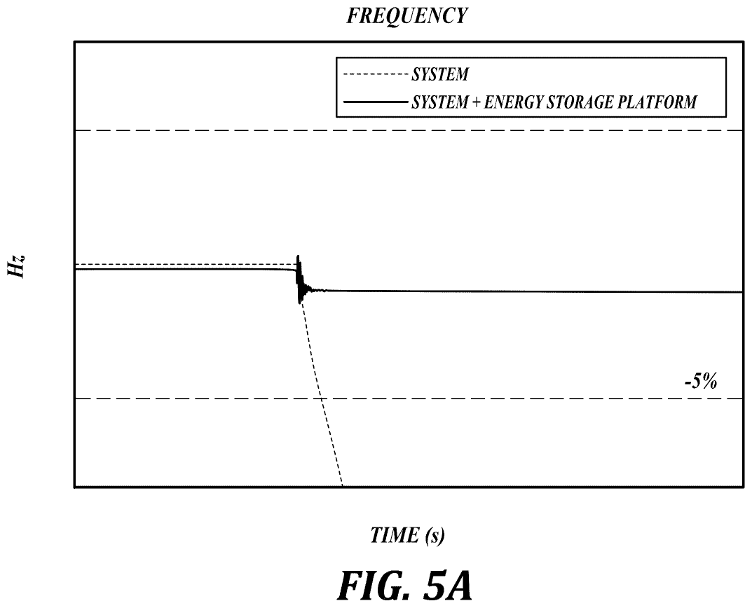

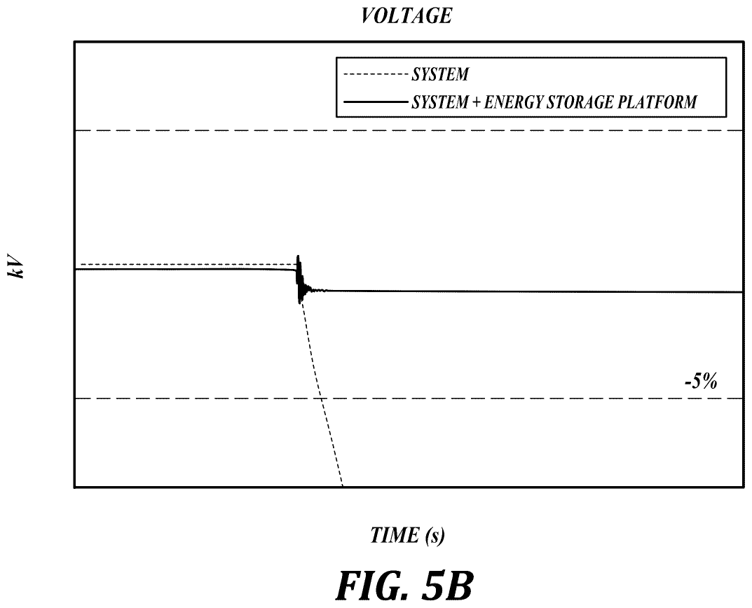

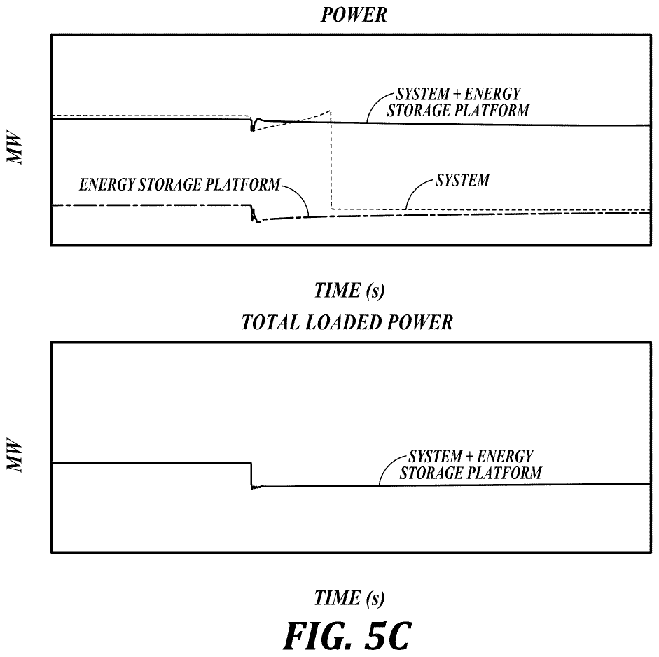

FIG. 5A and FIG. 5B illustrate graphical depictions of the frequency and voltage responses, respectively, of an electromagnetic transient (EMT) simulation of an islanded system with and without the energy storage platform during a loss of load, in accordance with the present technology. Similarly, FIG. 5C illustrates a graphical depiction of the power responses of a system with and without an energy storage platform, and an energy storage platform alone during a loss of load, in accordance with the present technology.

In the simulation illustrated graphically in FIGS. 5A, 5B, and 5 °C, four generators (in this instance, lean burn gas engines) were simulated for the system without an energy storage platform reliant on spinning reserve capacity, while the system with an energy storage platform featured three generators and relied upon non-spinning reserve capacity, in essence replacing one of the generators from the system without the energy storage platform. As discussed above, it should be understood that the example embodiment reflected in this simulation is not intended to be limiting in regards to the number or type of generators present in each simulation.

Referring to the portions of each graph concerning the system without the energy storage platform, a sudden loss of the load leaves the system momentarily with a surplus of generation due to the slow response of the speed governor and fuel delivery system of lean burn gas engines. This sudden surplus of generation on the system results in the frequency and voltage rising with a very fast rate of change. For such a large magnitude of a surplus generation, the engine speed governor is unable to react in a timely manner to bring the system under control (to regulate the over-frequency) and the system controller is unable to regulate the voltage for such rapid voltage changes, resulting in a loss of control that causes the collapse of frequency and voltage. This resulted in system protection measures being triggered, causing significant down time for the system where the load is unsupported.

Referring next to the portions of each graph concerning the system with the energy storage platform, a loss of load is similarly corrected with an energy storage platform configured to provide additional charging capacity. The system controller directs the surplus of power to the energy storage apparatuses momentarily to regulate the frequency, absorbing the additional momentary generation. Meanwhile, the engines unload gradually, reducing their power output in a controlled manner.

FIG. 5A and FIG. 5B show a substantially seamless frequency and voltage recovery following the loss of load with the energy storage platform supporting the system. FIG. 5C shows the energy storage platform power contribution during transients to support the system.

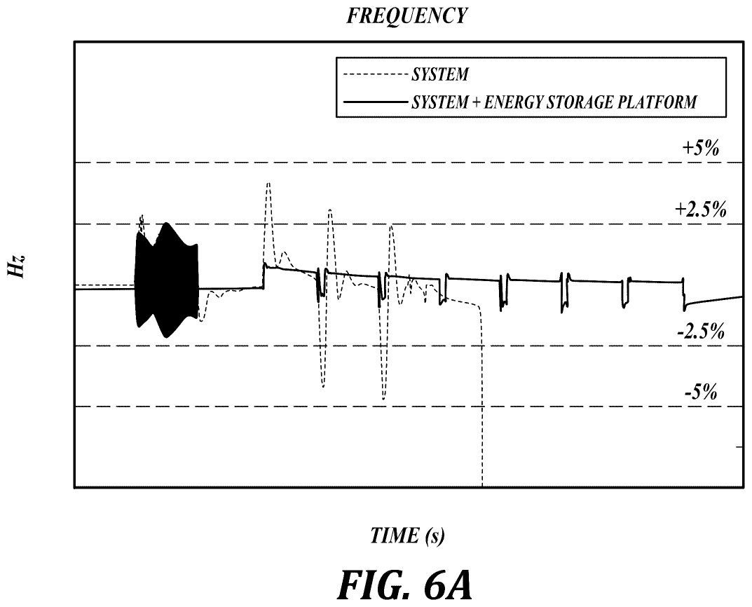

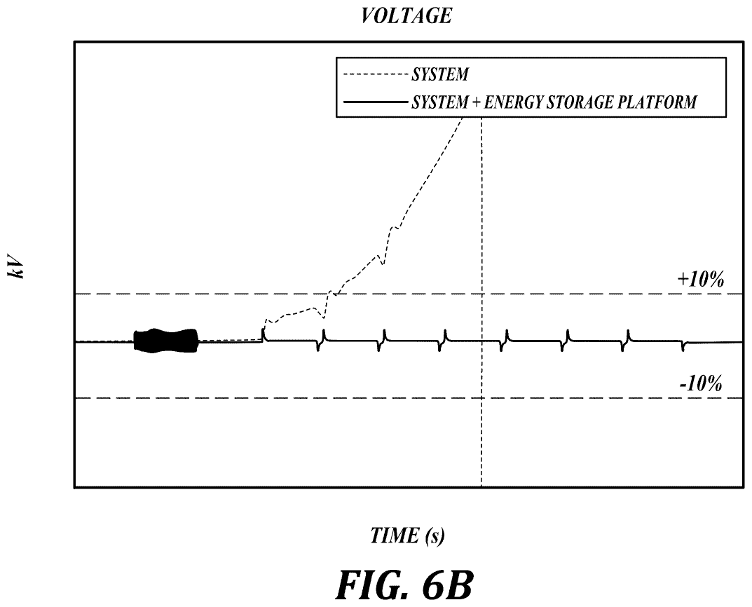

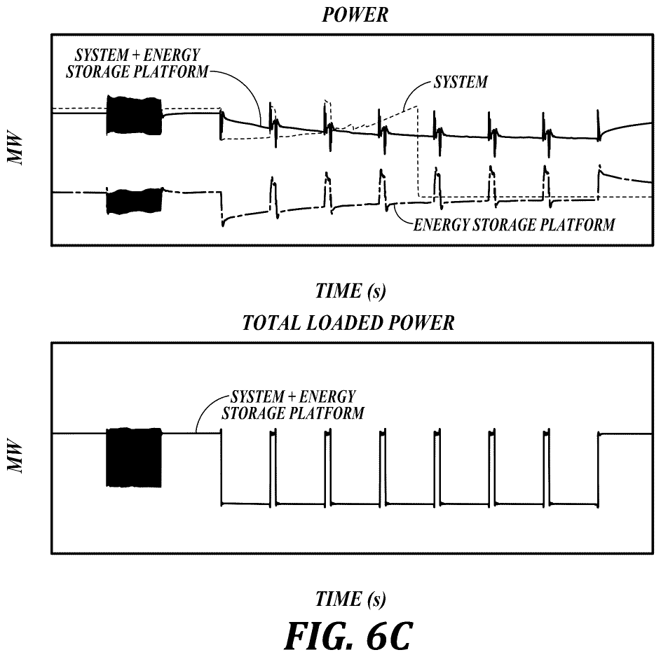

FIG. 6A and FIG. 6B illustrate graphical depictions of the frequency and voltage responses, respectively, of an electromagnetic transient (EMT) simulation of an islanded system with and without the energy storage platform during a pulsing/cycling load, in accordance with the present technology. Similarly, FIG. 6C illustrates a graphical depiction of the power responses of a system with and without an energy storage platform, and energy storage platform alone during a pulsing/cycling load, in accordance with the present technology.

In the illustrated simulation, four generators (in this instance, lean burn gas engines) were simulated for the system without an energy storage platform, while the system with an energy storage platform featured three generators, in essence replacing one of the generators from the system without the energy storage platform. As discussed above, it should be understood that the example embodiment reflected in this simulation is not intended to be limiting in regards to the number or type of generators present in each simulation.

In the simulation illustrated graphically in FIGS. 6A, 6B, and 6C, the pulse sizes and durations were selected to simulate an anticipated artificial intelligence or machine learning load. As discussed above, it should be understood that the example embodiment reflected in this simulation is not intended to be limiting in regards to the number or type of generators present in each simulation.

Referring to the portions of each graph concerning the system without the energy storage platform, sudden changes in voltage and frequency experienced with the pulsing/cycling loads result in system instability, as well as a loss of control for the system voltage and frequency. FIG. 6A and FIG. 6B demonstrate excessive voltage and frequency deviations (over voltage exceeds 10% and over frequency exceeds 5%) which causes the system to lose voltage and frequency regulation without the energy storage platform, ultimately leading to system collapse. The pulsing/cycling loads cause system protection measures to be triggered, causing significant down time for the system where the load is unsupported.

Referring next to the portions of each graph concerning the system with the energy storage platform, the system instability caused by frequency and voltage excursions of pulsing/cycling load effects was successfully mitigated by an energy storage platform capable of injecting the requisite power to ensure system continuity. As can be seen in FIG. 6A and FIG. 6B, the energy storage platform reduces the frequency and voltage deviations, respectively, compared to the system without the platform, resulting in a more stable system overall. FIG. 6C shows the energy storage platform power contribution during transients to support the system.

FIG. 7A illustrates a graphical depiction of power responses of the system after a pulsing/cycling load with a fixed power output, in accordance with the present technology. In the illustrated embodiment, the load is pulsing at a predictable, recurring rate. In the arrangement captured by the graph, the energy storage apparatuses of the ESS within the energy storage platform are configured to respond to the pulsing/cycling load, while the generators of the distributed generation unit within the power generation platform is set to a controlled power output, denoted by the horizontal dashed line. As such, the ESS energy storage apparatuses do not drain their charge while establishing the grid and responding to the pulsing/cycling load. Rather, the ESS energy storage apparatuses retain substantially the same SOC, with charging and discharging in equilibrium, by properly setting the fixed power command in the generators of the distributed generation unit.

The control mode represented in FIG. 7A represents a control scheme that is centered around the energy storage platform forming the grid and responding to the load, while the power generation platform follows the energy storage platform.

FIG. 7B illustrates a graphical depiction of power responses of the system after a pulsing/cycling load with a dynamically adjusting power output, in accordance with the present technology. In the illustrated embodiment, the load is pulsing at an irregular, unpredictable rate, such that pulse widths are non-uniform (a more common outcome than the uniform pulsing/cycling load denoted in FIG. 7A). In practice, pulsing load scenarios are often not symmetric (varying time durations) causing the battery SOC to either be too high or too low In the arrangement captured by the graph shown in FIG. 7B, the generators are configured to either provide more or less power to the ESS energy storage apparatuses, manipulating their state of charge (SOC) to force the batteries to charge or discharge, respectively. As such, the previously fixed power output of the generator denoted by the horizontal dashed line may rise or fall as the generator's output varies in response to the load. This may further allow the system controller to optimize the SOC required for a load that pulses indefinitely.

For the control mode represented in FIG. 7B, the power generation platform may adopt a minimum import/export approach, where the assets of the power generation platform (e.g., generators) either (1) provide additional power to the load to force the battery to charge when the SOC becomes too low (minimum export), or (2) provide less power to the load, forcing the energy storage platform to discharge when the SOC becomes too high (minimum import). (See FIG. 7B).

The control mode represented in FIG. 7B essentially allows for dynamically adjusting the fixed power command of the generators so that the ESS energy storage apparatuses SOC are optimized to respond to pulsing loads without the need for redundant batteries. As such, the ESS energy storage apparatuses SOC is neither too high nor too low. Rather, this control mode allows for the adjustment of the fixed power command of the generators such that the SOC becomes optimized to properly respond to pulsing loads indefinitely.

FIG. 8 illustrates a method 800 for stabilizing a power system during normal operation, in accordance with the present technology. It should be understood that components identified in method 800 are analogous to components identified in the utility-supported system 10000 and islanded system 11000 discussed in FIG. 1A, FIG. 1B, and FIG. 1C; however other components may also be used.

Beginning at block 802, the system controller may determine an optimal state of charge (SOC) for the energy storage platform. This may include analyzing the load or loads to determine the amount of power required to maintain normal operation. It may also include analyzing a utility source (see FIG. 1A) to determine the amount of power the load receives from the utility source during normal operation. Doing so may allow the system controller to identify the amount of power that will be required to be consistently produced by the energy storage platform if the load were to become disconnected from the utility source. In such an instance, the system controller may enable the energy storage controller to monitor the SOC of each energy storage system (ESS), as well as the subordinate energy storage apparatuses, ensuring that the energy storage platform has the requisite power to ensure stable power to the load(s). In some embodiments, this determination is communicated to the energy storage controller, allowing for the energy storage platform to respond to a load instability condition with zero latency.

As discussed above, the energy storage platform may be configured to simultaneously enable control voltage and frequency while also operating in a fixed power command, which are generally considered to be conflicting requirements according to conventional technology. This may be achieved by the system controller determining the proper sequence by which the energy storage platform is energized, as well as the proper voltage and frequency bounds for the operation of the energy storage platform in a utility-supported configuration while utilizing a decentralized approach (e.g., the inverter controller responds without specific direction from a system controller). This allows the energy storage platform to operate around a zero active and reactive power setpoint. The decentralized action is taken locally without any sort of timing delay. As such, the system controller plays a primary role in the slower, more deliberate changes inherent to the system (e.g., measured over the course of multiple cycles as opposed to sub-cycle responses).

This decentralized approach to system control allows other assets (e.g., spinning generators) to provide power to the load while the microgrid remains within healthy voltage and frequency bounds and the energy storage platform responds to support voltage and frequency when the system experiences a load instability condition. This may be enabled by the system controller's initial determination of an optimum SOC required for the energy storage platform to respond, as well as the system controller's coordination of any natural and programmed time delays between the assets. This communication architecture enables the system as a whole to operate using both droop and isochronous control as conditions demand.

Continuing to block 804, the system controller may determine an optimal number of power generation assets (e.g., generators) required to correct potential load instability conditions (see FIG. 9, FIG. 10, FIG. 11) as they arise. In some embodiments, this includes determining the number of generators required to maintain the optimal SOC of the energy storage platform. In some embodiments, this includes determining the amount of power required from the power generation platform (in addition to or in lieu of the energy storage platforms) required to stabilize the system in the event of an operational fluctuation (see FIG. 10, FIG. 11). The system controller may also, based on the power requirements of the load with and without a load instability condition, determine whether the one or more generators should be kept as a non-spinning reserve. In some embodiments, this determination is communicated to the generator controller, allowing for the power generation platform to respond to a load instability condition with zero latency.

The method continues to decision block 806, where the method 800 may differ based on whether the system is a utility-supported system (see FIG. 1A) or an islanded system (see FIG. 1B).

If the system is a utility-supported system, the method may proceed to block 808, where the utility source may charge the energy storage platform to its determined SOC and maintain this SOC through the course of normal operations. In some embodiments, the energy storage controller may monitor the SOC of the energy storage platform, enabling the energy storage apparatuses to charge or discharge as needed to ensure that this SOC is maintained. In some embodiments, the energy storage platform may receive power from a DC source instead of or in addition to the utility source. In some embodiments, the DC source is a renewable source of DC power (e.g., a solar panel array or similar). In other embodiments, the DC source is a non-renewable source of DC power (e.g., a diesel generator or similar).

Continuing to block 810, the energy storage platform may support the utility source. In some embodiments, this includes a grid-following control scheme such as phase-locked loop (“PLL”) that synchronizes the inverter's output power (supplied by at least one ESS) to the grid's alternating current (AC) power (i.e., the phase of the voltage/current). Such synchronization allows the energy storage platform to quickly (e.g., within a sub-cycle response timeframe) replace the utility source as a provider of power to the load (in the event of a loss or a mere deficit of utility generation) by constantly monitoring and mirroring the voltage and frequency of the utility source. For example, if the load were to suddenly become disconnected or insufficient from the utility source, the inverter(s) connected to the ESSes would immediately provide power in phase with the utility source to keep the voltage and frequency stable.

Continuing to block 812, the utility source may provide power to the load. In some embodiments, the energy storage platform may provide power to the load as well to assist with maintaining the determined SOC.

Returning to decision block 806, if the system is an islanded system, the method may proceed to block 814, where a DC source may charge the energy storage platform to its determined SOC. As discussed above, in some embodiments, the DC source is a renewable source of DC power (e.g., a solar panel array or similar). In other embodiments, the DC source is a non-renewable source of DC power (e.g., a diesel generator or similar).

Continuing to block 816, the energy storage platform may support the power generation platform while the power generation platform provides power to the load. In some embodiments, this includes a grid-following control scheme such as phase-locked loop (“PLL”) that synchronizes alternating current (AC) power (i.e., the phase of the voltage/current) provided by the ESS with that of the power generation platform. Such synchronization allows the energy storage platform to quickly (e.g., within a sub-cycle response timeframe) replace the power generation platform as a provider of power to the load (in the event of a loss or a mere deficit of utility generation) by constantly monitoring and mirroring the voltage and frequency of the power generation platform. For example, if the load were to suddenly become disconnected or insufficient from the power generation platform, the inverter(s) connected to the ESSes would immediately provide power in phase with the power generation platform to keep the voltage and frequency stable.

Continuing to block 818, the power generation platform may provide power to the load. In some embodiments, the energy storage platform may provide power to the load as well to assist with maintaining the determined SOC.

At this point, the branched method 800 reconvenes at block 820, where the system controller may detect a load instability condition. In some embodiments, the load instability condition is a loss of utility (see FIG. 9). In some embodiments, the load instability condition is a loss of generation (see FIG. 10). In some embodiments, the load instability condition is a pulsing/cycling load (see FIG. 11).

Continuing to block 822, the system controller may correct the load instability condition according to a system control algorithm, which may be implemented according to the methods 900, 1000, 1100 described in their corresponding figures as will be described below.

The method 800 then may repeat, beginning again back at block 808 or block 814 depending upon the configuration of the system 10000, 11000 and continues.

FIG. 9 illustrates a method 900 for stabilizing a power system following a loss of utility generation, in accordance with the present technology. It should be understood that this method 900 represents the response of a utility-supported system 10000 to a loss of that utility source, where the system transitions to an islanded system 11000. Referring to method 800 depicted in FIG. 8, this represents the detection and correction of a load instability condition as captured in blocks 820 and 822. It should also be understood that components identified in method 800 are analogous to components identified in the utility-supported system 10000 and islanded system 11000 discussed in FIG. 1A, FIG. 1B, and FIG. 1C; however other components may also be used.

Beginning at block 902, the system controller may detect a loss of frequency and/or voltage at the interconnection point. This may indicate that the utility source is no longer providing power to the load via the system power distribution bus-a load instability condition. Because the system controller has already provided the response to the requisite asset controllers (e.g., energy storage controller, inverter controller, and generator controller), the system control algorithm may enable the asset controllers to respond with zero latency.

Continuing to block 904, the utility source may isolate itself from the load. In some embodiments, this is accomplished by opening a recloser switch, circuit breaker, static switch assembly, or similar at the interconnection point.

Continuing to block 906, the energy storage platform may provide immediate power to the load, which is made possible by the energy storage platform monitoring and maintaining the determined SOC.

Continuing to block 908, the inverter unit(s) may transition to a grid-forming control scheme. In some embodiments, the inverter unit(s) that had previously supported the utility source may form an islanded system by ensuring the power provided by the energy storage platform is synchronized (voltage, frequency, phase) with the power that had previously been provided by the utility source, ensuring minimal degradation of service to the load. Such synchronization may be provided by, for example, PLLs described above.

Continuing to block 910, the system controller may enable the generator controller to activate the non-spinning power generation assets (e.g., generators) required to provide power to the load without the utility source. In some embodiments, this may include the system controller communicating the requisite voltage, phase, and frequency of the power provided by the energy storage platform to the generator controller to synchronize the generators with the power generation platform, again ensuring minimal degradation of service to the load. Such synchronization may be provided by, for example, PLLs described above.

Continuing to block 912, the power generation platform may begin providing power to the load.

Continuing to block 914, the energy storage controller may monitor the SOC of the energy storage platform.

Continuing to block 916, the power generation platform may provide power to the energy storage platform and maintain the determined SOC to respond to any future load instability conditions. In some embodiments, this may instead be accomplished by a DC source as described above.

Upon syncing the assets of the power generation platform (e.g., generators), the system for power stabilization is considered to be in an islanded configuration, and the load is no longer dependent upon the utility source for its power requirements. The energy storage platform may then gradually reduce its discharge while the generators gradually “load” at a predetermined rate that is acceptable for the generators to fully hand off the load from the energy storage platform to the power generation platform in a stable manner. The method 900 is then complete and the method 800 may resume at block 814.

FIG. 10 illustrates a method 1000 for stabilizing a power system following a loss of load, in accordance with the present technology. It should be understood that this method 1000 represents the response of an islanded system 11000 to a loss of load, where a load or loads becomes disconnected from the system power distribution bus. Referring to method 800 depicted in FIG. 8, this represents the detection and correction of a load instability condition as captured in blocks 820 and 822. It should also be understood that components identified in method 800 are analogous to components identified in the utility-supported system 10000 and islanded system 11000 discussed in FIG. 1A, FIG. 1B, and FIG. 1C; however other components may also be used.

Beginning at block 1002, the system controller may detect a loss of frequency and/or voltage at the load. This may indicate that the load has become disconnected from the system powering it, resulting in a surplus of power in the system that could in turn present a considerable risk of damage to the system and its subordinate components. Generally, the surplus of available power in the system, if not properly controlled, may lead to excessive frequency of the AC power. Because the system controller has already provided the response to the requisite asset controllers (e.g., energy storage controller, inverter controller, and generator controller), the system control algorithm may enable the asset controllers to respond with zero latency.

Continuing to block 1004, the energy storage controller may monitor the SOC of the energy storage platform.

Continuing to block 1006, the inverter controller may enable support of the power generation platform by following the AC power output by power generation platform in voltage, frequency, and phase to ensure that the energy storage platform is able to receive the power generated—power that, without a load, effectively has nowhere else to go.

Continuing to block 1008, the generator controller and energy storage controller may, in tandem, enable the generators of the power generation platform to briefly charge the energy storage apparatuses above their normal SOC. In some embodiments, this is accomplished by overcharging one or more of the already charged energy storage apparatuses. In other embodiments, one or more ESSes are left uncharged, allowing some or all of the energy storage apparatuses contained therein to receive the power surplus.

Continuing to block 1010, the energy storage apparatuses absorb the power surplus, as described above.

Continuing to block 1012, the system controller enables the generator controller may gradually “unload,” meaning that they reduce their power output in a controlled manner to maintain system stability. Doing so may protect the health and longevity of the generators until the load is reconnected to the system.

The method 1000 is then complete and the method 800 may resume at block 814.

FIG. 11 illustrates a method 1100 for stabilizing a power system in the event of a pulsing/cycling load, in accordance with the present technology. It should be understood that this method 110000 represents the response of a utility-supported system 10000 or an islanded system 11000 to a load profile wherein a load experiences rapid, occasionally periodic, fluctuations in power demanded. Referring to method 800 depicted in FIG. 8, this represents the detection and correction of a load instability condition as captured in blocks 820 and 822. It should also be understood that components identified in method 800 are analogous to components identified in the utility-supported system 10000 and islanded system 11000 discussed in FIG. 1A, FIG. 1B, and FIG. 1C; however other components may also be used.

Beginning in block 1102, the system controller may detect a pulsing/cycling load profile, wherein the load experiences rapid and variable changes in power requirements (e.g., rapid changes in machine learning or artificial intelligence computations).

Continuing to block 1104, the energy storage controller may monitor the SOC of the energy storage platform.

Continuing to block 1106, the system controller may determine, based on the frequency and degree to which the load profile is fluctuating, the optimal solution based at least in part on the initial SOC and power generation asset determinations made in blocks 802 and 804 of method 800. In some embodiments, the degree and frequency of the pulsing/cycling load may be known, in which case the system controller has already provided the response to the requisite asset controllers (e.g., energy storage controller, inverter controller, and generator controller), the system control algorithm may enable the asset controllers to respond with zero latency. In some embodiments, the degree and frequency of the pulsing/cycling load may not be known; however, because at least some aspect of the response (e.g., load fixed power requirements, determined SOC, etc.) have already been determined, the system control algorithm may enable the asset controllers to respond with minimal latency.

Depending upon the outcome of this determination, the method 1100 may rectify the load instability condition in one of two ways. Continuing to block 1108a, the generator controller may direct the power generation platform to provide a periodic fixed power output to the load while the energy storage platform stabilizes the load (see FIG. 7A). In some embodiments, this includes the energy storage apparatuses of the ESS within the energy storage platform retaining substantially the same SOC, with charging and discharging in equilibrium, by properly setting the fixed power command in the generators of the distributed generation unit. Without being beholden to theory, this may be most beneficial when the load is pulsing in a regular, predictable manner.

Alternatively, continuing to block 1108b, the generator controller may enable the power generation platform to perform minimum import/export to the energy storage platform. This may include the power generation assets (e.g., generators) either (1) providing additional power to the energy storage platform directly to force the battery to charge when the SOC becomes too low (minimum export), or (2) provide less power to the energy storage platform, forcing the battery to discharge when the SOC becomes too high (minimum import) (see FIG. 7B). Without being beholden to theory, this may be most beneficial when the load is pulsing in an irregular, sporadic manner.

The method 1100 then begins again at block 1102, continuing for the duration of the pulsing/cycling load. Once the load is no longer pulsing or cycling, the method 1100 is then complete and the method 800 may resume at block 814.

It should be understood that the above methods should be interpreted as merely representative. In some embodiments, process blocks may be performed simultaneously, sequentially, in a different order, or even omitted, without departing from the scope of this disclosure.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further nonlimiting examples of signal-bearing media include, but are not limited to, DVD-ROM, DVDRAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A system for power stabilization, comprising:
at least one load;
an energy storage platform, configured for providing power to the at least one load, comprising:
at least one energy storage system (ESS) configured for:
storing power; and
discharging power to the at least one load;
at least one inverter unit, configured for converting between direct current (DC) power and alternating current (AC) power; and
at least one energy storage platform bus configured for transferring power within the energy storage platform;
at least one system controller configured for:
monitoring the system;
determining an optimal level of energy storage for the energy storage platform;
detecting a load instability condition within the system; and
applying a system control algorithm to the system to correct the load instability condition; and
a system power distribution bus configured for transferring power within the system.

2. The system of claim 1, wherein the energy storage platform further comprises at least one endcap unit, comprising:
an endcap power collection module configured for transferring power from the energy storage platform bus to the at least one inverter unit; and
an ESS control module, configured for:
charging the ESS;
monitoring power stored within the ESS; and discharging power from the ESS.

3. The system of claim 2,
wherein the at least one ESS comprises:
a plurality of energy storage apparatuses;
at least one junction box; and
an ESS contactor;
wherein the ESS contactor is configured for transferring power from the plurality of energy storage apparatuses to the energy storage platform bus via the at least one junction box; and
wherein the at least one system controller is further configured for determining an optimal state of charge for the plurality of energy storage apparatuses.

4. The system of claim 2, further comprising a power generation platform, comprising:
at least one distributed generation unit, comprising:
a generator, configured for providing power to the system; and
a generator controller, configured for monitoring voltage and frequency of power output from the generator.

5. (canceled)

6. The system of claim 3, wherein the ESS control module comprises at least one energy storage controller configured for:
charging the plurality of energy storage apparatuses;
discharging the plurality of energy storage apparatuses; and
monitoring a state of charge for each of the plurality of energy storage apparatuses.

7. (canceled)

8. The system of claim 3, wherein the energy storage platform further comprises at least one isolation transformers, configured for:
adjusting voltage levels between the energy storage platform and the system;
transferring power between the energy storage platform and the system; and
isolating the energy storage platform from the at least one load.

9. The system of claim 8, wherein the energy storage platform is configured for:
charging the plurality of energy storage apparatuses with power received from the power generation platform; and
providing power to a DC load.

10. The system of claim 8, further comprising:
a utility source configured for providing continuous power to the at least one load; and
an interconnection point configured for:
connecting the utility source to the at least one load; and
disconnecting the utility source from the at least one load; and
wherein the at least one system controller is communicatively coupled with the utility source; and
wherein the at least one system controller is configured for monitoring a voltage and a frequency of the utility source;
wherein the system power distribution bus is connected to the utility source via the interconnection point.

11-12. (canceled)

13. The system of claim 10,
wherein the system further comprises a DC source;
wherein the energy storage platform is configured for receiving power from at least one of:
the utility source;
the power generation platform; and
the DC source; and
wherein the at least one energy storage controller is configured for charging the plurality of energy storage apparatuses with power received from at least one of:
the utility source;
the power generation platform; and
the DC source.

14. (canceled)

15. The system of claim 13, wherein the at least one inverter unit comprises:
an inverter, configured for operating in both a droop control scheme and an isochronous control scheme; and
an inverter controller configured for:
applying the droop control scheme to the inverter;
following a phase, a voltage, and a frequency of power provided by the utility source;
following a phase, a voltage, and a frequency of power provided by the power generation platform; and
applying the isochronous control scheme to the inverter.

16. The system of claim 15,
wherein the at least one system controller is communicatively coupled with the at least one energy storage controller, the inverter controller, and the generator controller; and
wherein applying a system control algorithm to the system to correct the load instability condition comprises:
applying, by the at least one energy storage controller, an energy storage control algorithm to the at least one ESS in response to the load instability condition;
applying, by the inverter controller, an inverter control algorithm to the inverter in response to the load instability condition; and
applying, by the generator controller, a generator control algorithm to the at least one distributed generation unit in response to the load instability condition;
wherein the system control algorithm enables the at least one energy storage controller, the inverter controller, and the generator controller to apply their respective control algorithms substantially without a timing delay.

17. The system of claim 16,
wherein the load instability condition is a loss of utility generation;
wherein the system control algorithm further comprises:
isolating the at least one load from the utility source;
wherein the energy storage control algorithm comprises:
discharging the plurality of energy storage apparatuses;
providing, by the energy storage platform, power to the at least one load via the at least one inverter unit; and
monitoring, by the energy storage controller, the state of charge of the plurality of energy storage apparatuses;
wherein the inverter control algorithm comprises:
entering, by the inverters, to a grid-forming control scheme; and
syncing, by the inverter controller, the power provided by the energy storage system with the voltage and the frequency of the utility source;
wherein the generator control algorithm comprises:
activating the at least one generator;
syncing the at least one generator with the voltage and the frequency of the utility source; and
providing power to the energy storage platform such that the optimal state of charge of the plurality of energy storage apparatuses is maintained;
wherein the at least one generator starts from a non-spinning state.

18. (canceled)

19. The system of claim 16,
wherein the load instability condition is a loss of load;
wherein the plurality of energy storage apparatuses is configured for absorbing a surplus of power in the system;
wherein the energy storage control algorithm comprises:
monitoring the state of charge of the plurality of energy storage apparatuses;
discharging the plurality of energy storage apparatuses; and
absorbing, by the energy storage platform, the surplus of power in the system;
wherein the inverter control algorithm comprises:
enabling support of the power generation platform;
wherein the generator control algorithm comprises:
briefly charging, by the generators, the plurality of energy storage apparatuses above the optimal state of charge;
reducing, by the generator controller, power output of the at least one generator.

20. (canceled)

21. The system of claim 16,
wherein the load instability condition is a pulsing/cycling load;
wherein the system control algorithm further comprises:
determining an optimal solution for the at least one load based on initial state of charge and power generation determinations;
wherein the energy storage control algorithm comprises:
discharging the plurality of energy storage apparatuses; and
monitoring the state of charge of the plurality of energy storage apparatuses;
wherein the inverter control algorithm comprises:
operating in grid-forming state;
providing continuous AC power to the at least one load;
wherein the generator control algorithm comprises:
providing, by the generators, continuous power to the at least one load to support a fixed power requirement; and
providing power to the energy storage platform such that the optimal state of charge of the plurality of energy storage apparatuses is maintained.

22. (canceled)

23. The system of claim 16,
wherein the at least one system controller includes a redundant network architecture configured for:
monitoring the system; and
applying the system control algorithm to the system to correct the load instability condition; and
wherein the applying the system control algorithm with the redundant network architecture includes a timing delay of 1-5 ms.

24. (canceled)

25. An energy storage platform, configured for stabilizing a power system, comprising:
at least one energy storage system (ESS) configured for:
storing power; and
providing power to at least one load;
at least one inverter unit configured for converting between direct current (DC) power and alternating current (AC) power; and
an energy storage platform bus configured for transferring power within the energy storage platform.

26. The energy storage platform of claim 25, wherein the energy storage platform further comprises at least one endcap unit, comprising:
an endcap power collection module configured for transferring power from the energy storage platform bus to the at least one inverter unit; and
an ESS control module, configured for:
charging the ESS;
monitoring power stored within the ESS; and
discharging power from the ESS.

27. The energy storage platform of claim 26,
wherein the at least one ESS comprises:
a plurality of energy storage apparatuses;
at least one junction box; and
an ESS contactor;
wherein the ESS contactor is configured for transferring power from the plurality of energy storage apparatuses to the energy storage platform bus via the at least one junction box; and
wherein the ESS control module comprises at least one energy storage controller configured for:
charging the plurality of energy storage apparatuses;
discharging the plurality of energy storage apparatuses; and
monitoring a state of charge for each of the plurality of energy storage apparatuses.

28-30. (canceled)

31. The energy storage platform of claim 25, wherein the energy storage platform further comprises at least one isolation transformer, configured for:
adjusting voltage levels between the energy storage platform and the system;
transferring power between the energy storage platform and the system; and
isolating the energy storage platform from the at least one load.

32. The energy storage platform of claim 25,
wherein the energy storage platform is configured for receiving power from at least one of:
a utility source;
a DC source;
a power generation platform, comprising:
at least one distributed generation unit, comprising
a generator, configured for providing power to the energy storage platform; and
a generator controller, configured for monitoring voltage and frequency of power output from the generator; and
wherein the at least one energy storage controller is configured for charging the plurality of energy storage apparatuses with power received from at least one of:
the utility source;
the DC source; and
the power generation platform.

33-34. (canceled)
